(19) United States
(12) Patent Application Publication
(10) Pub. No.: US 2023/0158965 A1
(43) Pub. Date: May 25, 2023

(54) Bike Rack

(71) Applicant: Michael Reed, Fruita, CO (US)

(72) Inventor: Michael Reed, Fruita, CO (US)

(21) Appl. No.: 17/991,634

(22) Filed: Nov. 21, 2022

Related U.S. Application Data
(60) Provisional application No. 63/281,446, filed on Nov. 19, 2021.

(51) Int. Cl. B60R 9/10

(52) U.S. Cl. CPC B60R 9/10

(57) ABSTRACT

A vehicle storage rack includes an extender that features a main beam interconnected with a first extender arm and a second extender arm. The extender arms have a bracketing clamps for securement. Support arms interconnect with the extender arms. Stiff-backs are interconnected with the extender arms and provide a platform for attachment of a vehicle storage tray interconnected therewith. A guide ramp is interconnectable with the vehicle storage tray to allow a motorcycle or similar vehicle to be loaded onto the vehicle storage tray and carried thereby.

### CROSS-REFERENCE TO RELATED APPLICATION

The present application claims the benefit of U.S. Provisional Patent Application No. 63/281,446, entitled “Bike Rack” and filed Nov. 19, 2021, the entire contents of which are incorporated by reference herein.

### BACKGROUND

Motorcycle racks and carriers that are connected to vehicles by hitch receivers are well known in the art. Traditionally, a hitch mounted carrier consists of a single 2″ steel or aluminum main support member. A single ⅝″ hitch pin is generally used to secure the carrier to the receiver. The standardized Class III receiver and 2″ materials allow for minor amounts of play. The resulting affect is rotational motion when the vehicle is traveling. Rough terrain or simple potholes can create unwanted movement or even loss of motorcycles or other items being carried.

### SUMMARY

Disclosed is an improved carrying rack and attachment system for motorcycles and like vehicles. An extender with a main support and two arms is affixed to a tow hitch and horizontal cross bar of a vehicle. The three points of contact achieved provide rigidity to the overall system. Support arms interconnect with the extender and interface with stiff-backs that hold a vehicle storage tray configured to receive the stowed vehicle. A guide ramp is affixable to the vehicle storage tray so that a vehicle can be raised up and secured in the vehicle storage tray, preferably via a wheel chock and a wheel stop. The extender permits the use of spare tire and other storage configurations on the backs of vehicles while still permitting the carrying of a motorcycle. The stiff-backs provide modularity to the system and may be switched out to accommodate expansion of the system.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIGS. 1A-B depict an assembled and blown-up view, respectively, of an embodiment vehicle carrying rack.

FIGS. 2A-G depict plan vs of a second embodiment vehicle.

### DETAILED DESCRIPTION

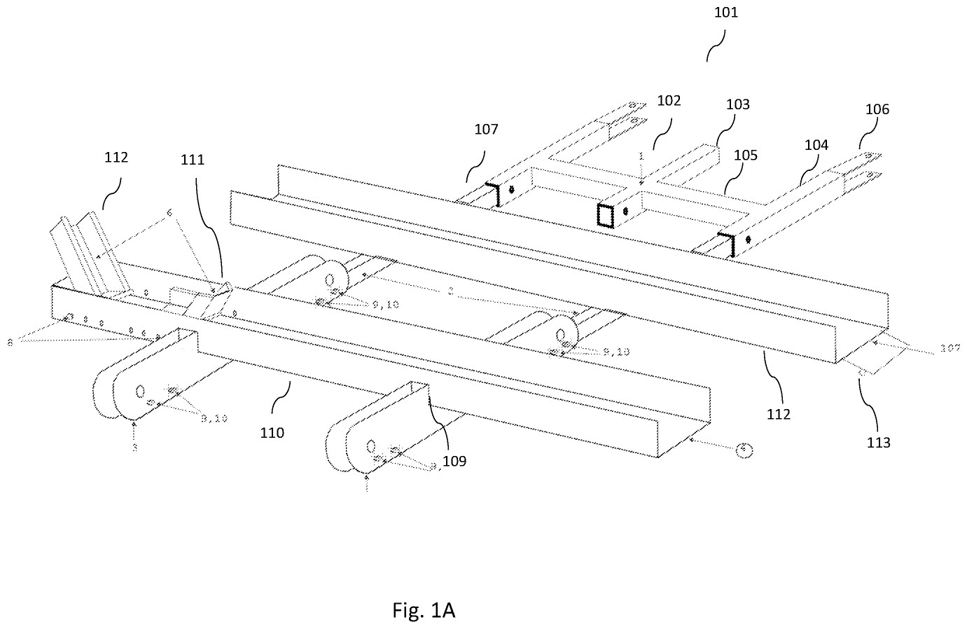

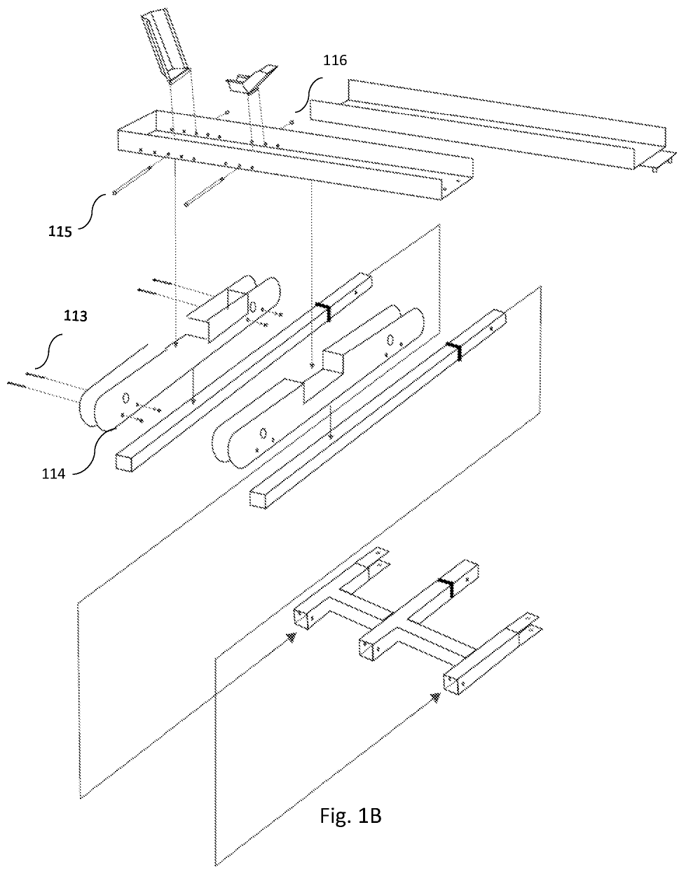

Now with reference to FIGS. 1A-B, an embodiment vehicle storage rack 101 includes an extender 102 that provides stabilization and improved weight loading over previous designs. The extender includes a main beam 103 which is configured to be connectable to standard automotive tow hitches. In the embodiment, the extender is connected to parallel extender arms 104 via perpendicular connector arms 105. Each of the extender arms include a bracketing clamp 106 that, in the embodiment, is two horizontal plates with holes configured to receive bolts that when locked in place clamp to a horizontal cross bar of the host vehicle. This provides improved base stability to the vehicle storage rack 101 over existing designs.

In certain manufactured embodiments, the extender includes one 2″-½″×¼′ square A500 steel main support beam with laser cut 21/32″ holes on the two vertical faces for specification of class III OEM and aftermarket receiver hitch pins. The main beam is connected by structural filet welds to two perpendicular 2″-½″×¼″ square A500 steel connector arms. The outer 2½″×¼″ square A500 steel extender arms are parallel to the main beam embodiment and welded to the connector arms by structural filet welds. The bracketing clamps are made from A500 steel and effectively squeeze clamp the horizontal cross bar and are structurally filet welded to the extender arms.

Support arms 107 are interconnected with the parallel extender arms 104. In certain embodiments, both the parallel extender arms 104 and the support arms 107 are square profile hollow rails, with the support arms 107 are preferably undersized relative to the parallel extender arms 104 such that they readily slide within the parallel extender arms while being sized to closely fit therewithin.

In certain manufactured embodiments, the support arms 107 are formed from 2″×¼″ square A500 steel. Each is approximately 36″ in length and has four (4) laser cut ⅝″ holes which are spaced to specification to accept additional elements.

Stiff-backs 108 are interconnected to the support arms 107. The stiff-backs 108 are in certain embodiments two rounded rectangular plates connected via a section of square profile tubular metal. The stiff-backs 108 each include a connection interface 109 configured to receive a vehicle storage tray 110. A wheel chock 111 and a wheel stop 112 serve to secure a motorcycle or like device within the vehicle storage tray 110. A ramp 112 is connectable to the vehicle storage tray 110 via a hinged connection plate 113. The ramp 112 may be made to be stowable with the stiff backs 108 via bolts or other similar securement devices, or may be stored separately when not in use. In certain manufactured embodiments, bolts 113 are 8″×½″ bolts, nuts 114 are ½″ nyloc nuts, bolts 115 are 4½″× 5/16″ bolts and nuts 116 are 5/16″ nyloc nuts.

The stiff-backs in certain manufactured embodiments consists of dual ¼″ 6061 aluminum laser cut plates. Each embodiment is joined by structural weld using 1.5″×¾″ aluminum tubing in two locations to create the required spacing needed to attach each stiff-back to the support arms. The vehicle tray is a single ⅛″ 6061 aluminum sheet. This embodiment is laser cut to specification and machine bent at 90-degree angles to create rigidity and strength. Attached to the tray are two aluminum mechanisms deemed a wheel chocks and wheel stop which are formed from ⅛″ 6061 aluminum. These items are also laser cut and bent to form concave structures which receive and cradle the front wheel of the motorcycle. The final element is an accompanying accessory ramp. This is used for the loading and unloading of the carried motorcycle. In certain manufactured embodiments it is built from ⅛″ 6061 aluminum which is laser cut and mechanically bent to 90-degree angles to achieve rigidity and strength.

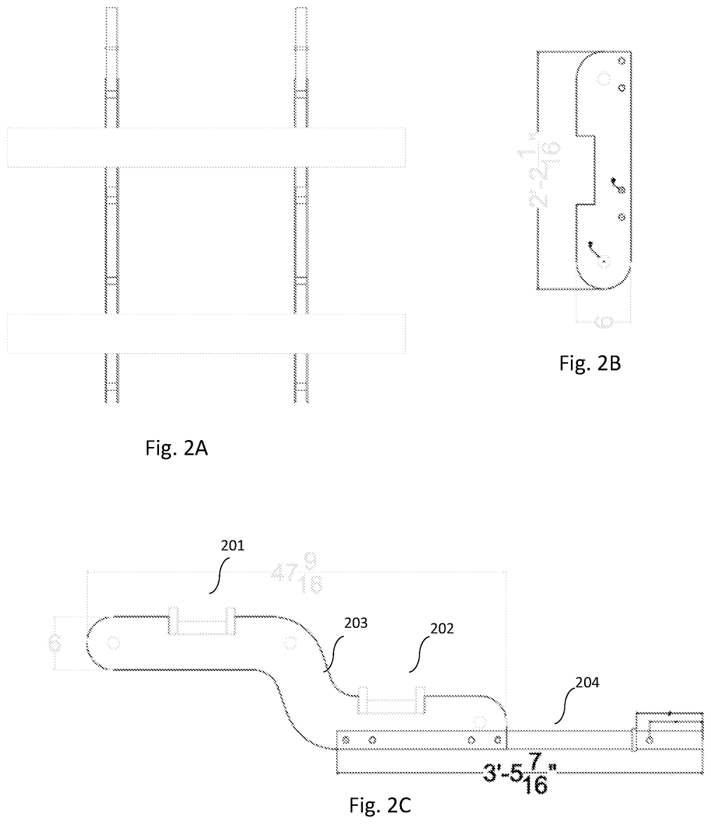

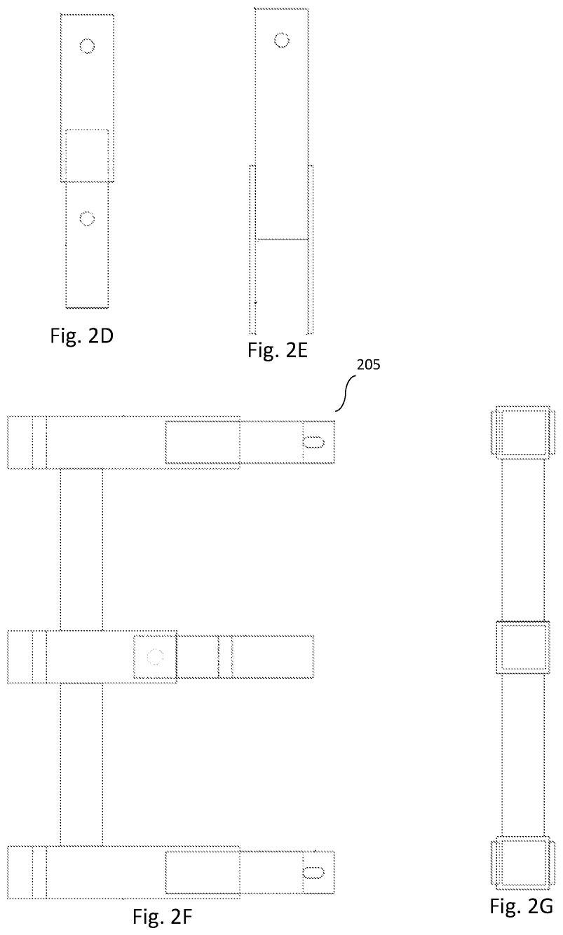

FIGS. 2A-G depict plan views of a second embodiment having a vehicle storage tray 201, a ramp 202, stiff-backs 203, support arms 204 and an extender 205.

One advantage of the present disclosure is to increase the safety and stability of motorcycle hitch mounted devices. The weight distribution is improved by spreading the load across three points of contact and reinforcing the mechanism with engineered materials tested and certified by steel manufacturers. The invention decreases the rotational movement and provides a substantial improvement to previous designs.

Forming the extender and support arms from steel provides excellent rigidity to the overall system while forming the stiff-backs, storage tray and guide ramp from aluminum reduces the overall weight of the system. The stiff-backs being selectively detachable from the support arms allows the storage tray and ramp system to be modular and expandable without needing a complete new system or the uninstallation of the extender and support arms. For example, stiff-backs supporting multiple motorcycles may be easily installed.

What is claimed:

1. A vehicle storage rack, comprising:
an extender including a main beam interconnected with a first extender arm and a second extender arm;
wherein the first extender arm and second extender arm each have a bracketing clamp;
a first support arm interconnected with the first extender arm and a second support arm interconnected with the second extender arm;
a first stiff-back interconnected with the first support and a second stiff-back interconnected with the second support arm, wherein each of the first stiff-back and the second stiff-back have a connection interface;
a vehicle storage tray interconnected with the connection interface of each of the first stiff-back and the second stiff-back; and
a guide ramp interconnectable with the vehicle storage tray.

2. The vehicle storage rack of claim 1 wherein the extender, first support arm and second support arm are formed from one of steel or a steel alloy.

3. The vehicle storage rack of claim 2 wherein the first stiff-back, the second stiff-back, the vehicle storage tray and the guide ramp are formed from one of aluminum or an aluminum alloy.

4. The vehicle storage rack of claim 1 wherein the guide ramp is stowable to the first stiff-back and the second stiff-back.

5. The vehicle storage rack of claim 1 wherein the vehicle storage tray includes a wheel chock.

6. The vehicle storage rack of claim 1 wherein the vehicle storage tray includes a wheel stop.

7. The vehicle storage rack of claim 1 wherein the guide ramp is interconnectable with the vehicle storage tray via a hinged connection plate.
